(19) United States
(12) Patent Application Publication
(10) Pub. No.: US 2025/0190649 A1
(43) Pub. Date: Jun. 12, 2025

(54) POWER MANAGEMENT OPTIMIZATION FOR HYBRID POWER SOURCES

(71) Applicant: Caterpillar Inc., Peoria, IL (US)

(72) Inventors: Perry Dwain Converse, Lafayette, IN (US); Gavin Williams, Lincolnshire (GB); Dhrupad Biswas, West Bengal (IN)

(73) Assignee: Caterpillar Inc., Peoria, IL (US)

(21) Appl. No.: 18/535,142

(22) Filed: Dec. 11, 2023

(51) Int. Cl. G06F 30/20; G06F 119/06

(52) U.S. Cl. CPC G06F 30/20; G06F 2119/06

(57) ABSTRACT

A method and system for optimizing power management for a hybrid system of a machine are provided. The method includes generating a plant model based on a machine recipe of the machine; generating, in an algorithm library, algorithms for a plurality of scenarios simulated based on selected key performance indicators (KPIs) associated with the machine recipe, optimization connections, and machine requirements of the machine; selecting an algorithm from the algorithm library based on computational capabilities of a controller associated with the machine and machine requirements for the algorithm; simplifying the algorithm based on removing one or more KPIs of the selected KPIs; refining the algorithm based on weighing one or more remaining KPIs of the selected KPIs; and integrating the algorithm into machine operation to be performed by a control module of the machine.

### TECHNICAL FIELD

The present disclosure relates generally to a system and method for optimizing power management of hybrid power sources, and more particularly, to a system and method for optimizing energy source distribution between a stored electrical energy source, such as batteries, and a generated electrical energy source, such as a fuel cell.

### BACKGROUND

When operating a power system having multiple power sources of various types and capabilities available for common loads, it is difficult to determine an optimal power distribution of the available power sources for a given load in real-time. The load may require different target points, or goals, based on, for example, current priorities of the power system. For example, a fuel cell hybrid machine with batteries may include a battery management system and battery thermal management system with possible converters to deliver power to a load. The fuel cell hybrid machine may also include a stack cooling and the efficiency vary based on overall output. There may also be an auxiliary cooling system for balancing a fuel cell and converters. Including consideration for efficiency losses and environmental conditions to determine an optimal power distribution for a given load can be complex.

One example of a power management system for adjusting power distribution, such as a system in a hybrid electric vehicle, to improve fuel consumption is disclosed in Chinese Patent Application Publication No. 113602252A of Xing et al., that was published on Nov. 5, 2021 (“the '252 publication”). In particular, the '252 publication discloses a control method and a device for a hybrid electric vehicle, which include establishing a working condition mode neural network model according to driving characteristics of each typical working condition; performing offline optimization calculation on each typical working condition according to a dynamic programming algorithm to obtain an optimal power distribution strategy of each typical working condition; establishing a power distribution neural network model according to the optimal power distribution strategy of each typical working condition; when the vehicle is in a running state, obtaining a typical working condition corresponding to the current working condition of the vehicle according to the working condition mode neural network model; and calling corresponding power distribution neural network model according to the typical working condition corresponding to the current working condition, and outputting output power signals of an engine and a driving motor of the vehicle to form an optimal power distribution strategy.

Although useful in determining the energy source distribution, or portioning of the energy sources, for a load, the power management system of the '252 publication may be limited. In particular, the '252 publication describes determining distribution of power from of the energy sources comprising an internal combustion engine (ICE) and a battery-powered motor, based on different working conditions, for optimizing fuel economy of a hybrid vehicle.

The systems and methods described herein are directed to addressing one or more of the drawbacks set forth above.

### SUMMARY

According to a first aspect, a method for optimizing power management for a hybrid system of a machine is provided. The method includes generating a plant model based on a machine recipe of the machine, generating, in an algorithm library, algorithms for a plurality of scenarios simulated based on selected key performance indicators (KPIs) associated with the machine recipe, optimization connections, and machine requirements of the machine, selecting an algorithm from the algorithm library based on computational capabilities of a controller associated with the machine and machine requirements for the algorithm, simplifying the algorithm based on removing one or more KPIs of the selected KPIs, refining the algorithm based on weighing one or more remaining KPIs of the selected KPIs, and integrating the algorithm into machine operation to be performed by a control module of the machine.

According to another aspect, a system is provided for optimizing power management for a hybrid system of a machine. The system includes one or more processors and memory communicatively coupled to the one or more processors. The memory stores processor-executable instructions that, when executed by the one or more processors, cause the one or more processors to perform operations. The operations include generating a plant model based on a machine recipe of the machine, generating, in an algorithm library, algorithms for a plurality of scenarios simulated based on selected key performance indicators (KPIs) associated with the machine recipe, optimization connections, and machine requirements of the machine, selecting an algorithm from the algorithm library based on computational capabilities of a controller associated with the machine and machine requirements for the algorithm, simplifying the algorithm based on removing one or more KPIs of the selected KPIs, refining the algorithm based on weighing one or more remaining KPIs of the selected KPIs, and integrating the algorithm into machine operation to be performed by a control module of the machine.

According to yet another aspect, non-transitory computer-readable medium is provided that stores thereon processor-executable instructions that, when executed by one or more processors of a system, cause the one or more processors to perform certain operations for optimizing power management for a hybrid system of a machine. The operations include generating a plant model based on a machine recipe of the machine, generating, in an algorithm library, algorithms for a plurality of scenarios simulated based on selected key performance indicators (KPIs) associated with the machine recipe, optimization connections selected from a digital twin of the machine, and machine requirements of the machine, selecting an algorithm from the algorithm library based on computational capabilities of a controller associated with the machine and machine requirements for the algorithm, simplifying the algorithm based on removing one or more KPIs of the selected KPIs, refining the algorithm based on weighing one or more remaining KPIs of the selected KPIs, and integrating the algorithm into machine operation to be performed by a control module of the machine.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is a side view of an exemplary machine that may utilize optimizing power management for a hybrid power source of the machine.

FIG. 2 is a flowchart illustrating a process for optimizing power management for a hybrid power source of the machine.

FIG. 3 is a block diagram model of the machine based on the machine recipe.

FIG. 4 is a flowchart representing an example detail process of one of the blocks of FIG. 2.

FIG. 5 is a flowchart representing an example detail process of one of the blocks of FIG. 2.

FIG. 6 is a flowchart representing an example detail process of one of the blocks of FIG. 2.

FIG. 7 is a block diagram of a system for optimizing power management for a hybrid power source of the machine.

### DETAILED DESCRIPTION

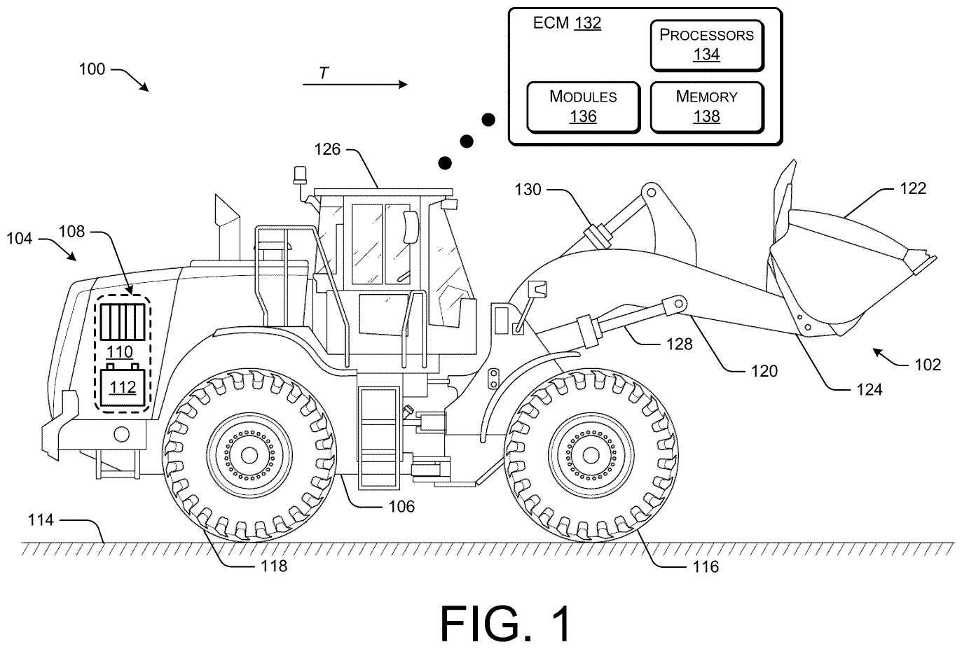

FIG. 1 is a side view of an exemplary machine 100 that may utilize optimizing power management for a hybrid power source of the machine 100. The machine 100 is depicted as an earth moving machine, e.g., a wheel loader. However, the machine 100 may be any type of machine configured with a hybrid power source, such as an automobile, a truck, an agricultural vehicle, an aircraft, a watercraft, and/or work vehicles, such as a track loader, a skid-steer loader, a grader, an on-highway truck, an off-highway truck, and/or any other machine known to a person skilled in the art.

The machine 100 may include a forward end 102 and a rearward end 104. The forward end 102 and the rearward end 104 may be opposite to each other. The forward end 102 and the rearward end 104 may be defined in relation to an exemplary direction of travel, T, of the machine 100, with the direction of travel, T, being defined from the rearward end 104 towards the forward end 102.

The machine 100 may include a frame or a chassis 106. The chassis 106 may support a variety of machine parts, e.g., a hybrid power source 108 to power one or more functions of the machine 100. The hybrid power source 108 may include one or more of a fuel cell 110 and a battery 112 to provide electricity to powertrains, although powertrains running from other known methods and sources may also be applicable. The chassis 106 may be supported on surface 114 by wheels (e.g., forward wheels 116 and rearward wheels 118) that may be powered by the hybrid power source 108 to move or rotate and facilitate machine propulsion. The machine 100 may include a lift arm assembly 120 (or a pair of lift arms) hinged or pivotably coupled to the chassis 106, as shown. An implement 122 (such as a bucket) may be provided at a distal end 124 of the lift arm assembly 120 (or at the forward end 102) to perform work, e.g., to scoop in material from a material bank. While the implement 122 is depicted as a bucket, it may be understood that the implement 122 may represent or include, but not limited to, blades, forks, and multiple varieties of buckets, such as toothed buckets, ejector buckets, side dump buckets, demolition buckets, and the like.

The chassis 106 may also support an operator cabin 126 that may station one or more operators of the machine 100 therein. The operator cabin 126 may house various devices accessing one or more of which may help an operator control the machine's movement and/or operation. For example, the operator cabin 126 may include one or more input devices, e.g., an input device that may be used and/or be actuated by an operator to control and/or perform one or more tasks with the machine 100 (e.g., for moving the machine 100 back and forth, for moving the implement 122, etc.).

The machine 100 may include one or more lift cylinders 128 and one or more tilt cylinders 130. The lift cylinders 128 may be hydraulically actuated cylinders and may include a cylinder-rod-based arrangement, which may be applied to raise and lower the implement 122 with respect to the surface 114. The lift cylinders 128 may be operatively coupled between the chassis 106 and the lift arm assembly 120. An extension of the lift cylinders 128 (i.e., an extension of the rod outward of the corresponding cylinder) may cause the implement 122 to be raised with respect to the surface 114 or the chassis 106 of the machine 100. Conversely, a retraction of the lift cylinders 128 (i.e., a retraction of the rod into the corresponding cylinder) may cause the implement 122 to be lowered with respect to the surface 114 or the chassis 106 of the machine 100.

The tilt cylinders 130 may be hydraulically actuated cylinders as well. The tilt cylinders 130 may be applied to rotate the implement 122 (e.g., the bucket) relative to the lift arm assembly 120. As an example, the tilt cylinders 130 may be operatively coupled between the implement 122 and the lift arm assembly 120 (or the chassis 106 of the machine 100), and may be retractable and extendable to appropriately cause the implement 122 to rotate or tilt with respect to the lift arm assembly 120.

In some examples, an operator operating the machine 100 may provide a selection of a task of one or more tasks via an input device. The input device may be representative of or may include, but is not limited to, one or more steering devices (not shown) that may be used to turn the forward wheels 116 and change machine direction during travel. The input device may also be representative of one or more pedals or levers (not shown) to accelerate and/or decelerate the machine 100. Additionally, the input device may also be representative of touch screens, joysticks, switches, and the like. In some embodiments, where the machine 100 may be operated autonomously or semi-autonomously, the input device may be omitted from operator cabin 126 and may instead be located remotely to the machine 100 or to the site of the machine's operations.

As described above, the machine 100 may include one or more batteries 112 to power various electrical equipment in the machine 100 such as one or more electric motors used as prime movers and to power one or more functions of the machine 100. For example, the machine 100 may include an electronic control module (ECM) 132 that houses one or more processors 134, which may execute any modules, components, or systems associated with the machine 100, some of which may be housed in the ECM 132 as shown as modules 136. In some examples, the processors 134 may include a central processing unit (CPU), a graphics processing unit (GPU), both CPU and GPU, or other processing units or components known in the art. Additionally, each of the processors 134 may possess its own local memory, which also may store program modules, program data, and/or one or more operating systems.

Computer-readable media, such as memory 138, associated with the machine 100 may include volatile memory (e.g., RAM), non-volatile memory (e.g., ROM, flash memory, miniature hard drive, memory card, or the like), or some combination thereof. The computer-readable media may be non-transitory computer-readable media. The computer-readable media may include or be associated with the one or more of the above-noted modules, which perform various operations associated with the machine 100. In some examples, one or more of the modules may include or be associated with computer-executable, or processor-executable, instructions that are stored by the computer-readable media and that are executable by one or more processors to perform such operations.

The ECM 132 may receive a task selected from one or more tasks. Each task of the one or more tasks may be associated with a corresponding movement pattern of the machine 100. Examples of the one or more tasks may include, but not limited to, a task associated with lifting the implement 122 (e.g., a bucket), a task associated with moving the machine 100 from a first location to a second location (e.g., backing up the machine 100 from a material bank to the second location), a task associated with moving the machine 100 from the second location to a third location (e.g., moving the machine 100 from the second location to a dumpsite), a task associated with applying a brake under propulsion, a task associated with steering the machine 100 with the implement 122 high in the air, etc.

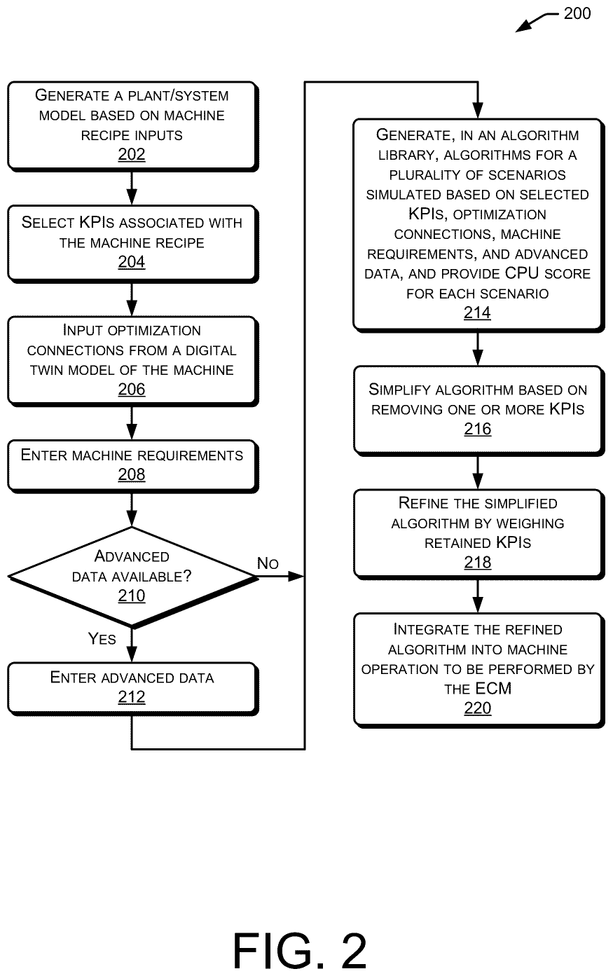

FIG. 2 is a flowchart 200 illustrating a process for optimizing power management for the hybrid power source 108 of the machine 100. The flowchart 200 is illustrated as a logical flow graph, operation of which represents a sequence of operations that can be implemented in hardware, software, or a combination thereof.

At block 202, a plant, or system, model is generated based on a machine recipe for optimizing power management for a hybrid system of a desired machine, such as the hybrid power source 108 of the machine 100. For example, the machine recipe, selected and input, may include various models for: a power source, such as the fuel cell/battery hybrid power source 108; a bus architecture, such as a common DC bus with an onboard charger; a drivetrain, such as a differential steer; and hydraulics, such as a dual pump system for an implement and/or tracks of the machine 100. At block 204, key performance indicators (KPIs) associated with the machine recipe are selected. KPIs for a fuel cell may include: hydrogen (H2) fuel consumption-efficiency maps and kg-H2/Amps metric; State of Health (SoH) of the fuel cell associated with purge, start-stop, load, and transient states; balance of plant (BoP) for efficiency; and DC-DC converter efficiency curves such as voltage and current vs percentage efficiency. KPIs for a battery may include: a target state of charge (SoC); and SoH for cyclic and calendar aging. KPIs for a battery thermal management system may include: thermal efficiencies associated with active mode, passive mode, and combined mode; and electrical efficiencies associated with compressor speed, coolant pump speed, and fan speed. KPIs for an overall system may include: time convergence associated with the SoC, i.e., battery charging time target; time convergence associated with H2, i.e., H2 refueling; and a total electrical efficiency loss. KPIs for a machine level may include tons/hour, system efficiency, and/or acceleration time. KPIs for controls may include component, sub-system, and/or system level that influence the machine level KPIs, such as hybrid power split, parasitic electrical efficiency, powertrain efficiency, DC-DC load sharing, etc.

At block 206, areas of optimization connections, including physical connections selected from a digital twin model of the machine 100, control connections, and plant connections are entered. Each type of machines has a corresponding digital twin model, which includes electrical and mechanical connections with a controller specific to the machine. Mechanical connections are a part of the Control and Plant interdependencies, and define how and by which controller and critical control signals components are controlled. Electrical connections define connections between devices, power flow for the low voltage bus, high voltage bus, parasitics, and loads, and define what components influence the electrical flow through the system. Control defines how the controllers are connected to the electrical and mechanical components to identify the degrees of freedom and which signals are required locally, or remote, in the system control. The physical connections may include: 1) mechanical connections of the machine 100; 2) electrical connections associated with the hybrid power split of the hybrid power source 108 including a fuel cell BoP on the common DC bus, fuel cell output on a high voltage bus to a DC-DC converter, fuel cell DC-DC converter output on a high voltage common bus, and a battery output on the high voltage common bus; and 3) rated capabilities and operating ranges for a fuel cell, a battery module and a charger, and a fuel cell DC-DC converter.

The control connections may include: 1) boundary criteria for controlling a DC-DC converter current limit and SoH of the battery 112; 2) interface for pulling from a library the control, information, and safety signals from components such as the fuel cell regarding voltage, current, and maximum current limit, the battery regarding voltage, current, and maximum current limit, the DC-DC converter regarding a current control and a reference current, and hydrogen storage regarding a percentage of H2 stored and H2 rated capability; 3) controller network, that identifies component controllers and supervisory controllers including how they are connected for datalink architecture, including a fuel cell controller connection to a first datalink (Datalink A), a fuel cell safety controller connection to Datalink A, a fuel cell DC-DC converter connection to Datalink A, a hydrogen storage controller connection to Datalink A, a battery connection to a second datalink (Datalink B), and supervisory controller connection to Datalink A and Datalink B. The plan connections may: 1) create the connections between Physical Machine model and controls; and 2) determine areas of optimization where the control connections interface with physical ones including a fuel cell DC-DC converter current reference, and a fuel cell start and stop stages.

At block 208, machine requirements for the machine 100 are entered. The machine requirement may include: a total cost of ownership (TCO) such as total efficiency loss minimization and H2 consumption minimization; regulatory requirements; and performance criteria such as a constant speed operation for a dial determined variable torque motor operation. At block 210, advanced data availability is checked. The advanced data may include machine automation information and site data associated with locations where the machine 100 operates including locations of chargers and H2 refueling stations. If the advance data are available, the advanced data are entered at block 212, and the process advances to block 214. If the advanced data are not available, the process skips block 212 and advances to block 214.

At 214, algorithms are generated in an algorithm library for a plurality of scenarios simulated and/or evaluated based on the selected KPIs, the optimization connections, the machine requirements, and advanced data associated with the machine 100. Each scenario simulated is given a central processing unit (CPU) score that indicates computational requirements for a given task, where a higher CPU score indicates a higher computational requirements. An algorithm may be selected based on computational capabilities of the controller associated with the machine, such as the CPU score and machine requirements for the algorithm. The CPU score is a calculated value or determined by running a hardware in loop simulation of various levels of complexity from the machine application and optimization algorithm. The CPU score may be utilized to develop an available score (flops) of remaining CPU power available for the optimal control. The plurality of scenarios may include a baseline evaluation, algorithm determination, and controller benchmarking. While suitable to be executed by a large computer or a computing system, such as a cloud, or distributed computing system, the algorithm generated may be large to be executed by the processors 134 of the ECM 132 of the machine 100 in real-time. At block 216, the algorithm is simplified, i.e., the computational requirements of the algorithm are reduced, based on removing one or more KPIs of the selected KPIs. For example, a KPI that has a small impact on the CPU score may be removed from the plurality of scenarios simulated.

At block 218, the simplified algorithm is further refined by weighing, or prioritizing, retained KPIs for enabling the refined algorithm to run with the plant model. Each KPI has two main outputs: 1) an effect of the KPI on the output of the control, and 2) priority of the KPI in alignment with the machine requirements. Based on this two-level ranking, a KPI may be removed from the optimization algorithm to the point where the optimization algorithm is able to operate within the CPU availability (flops). The refined algorithm may have a CPU score that is low enough such that it can be run on the processors 134 of the ECM 132 of the machine 100 to produce adequate results within a reasonable time period. At block 220, the refined algorithm is integrated into machine operation to be performed by the ECM 132, that is, machine operation program, code, or script that has integrated the refined algorithm, is sufficiently reduced in size and complexity to be loaded on the memory 138 and the processors 134 execute the machine operation program for operating the machine 100.

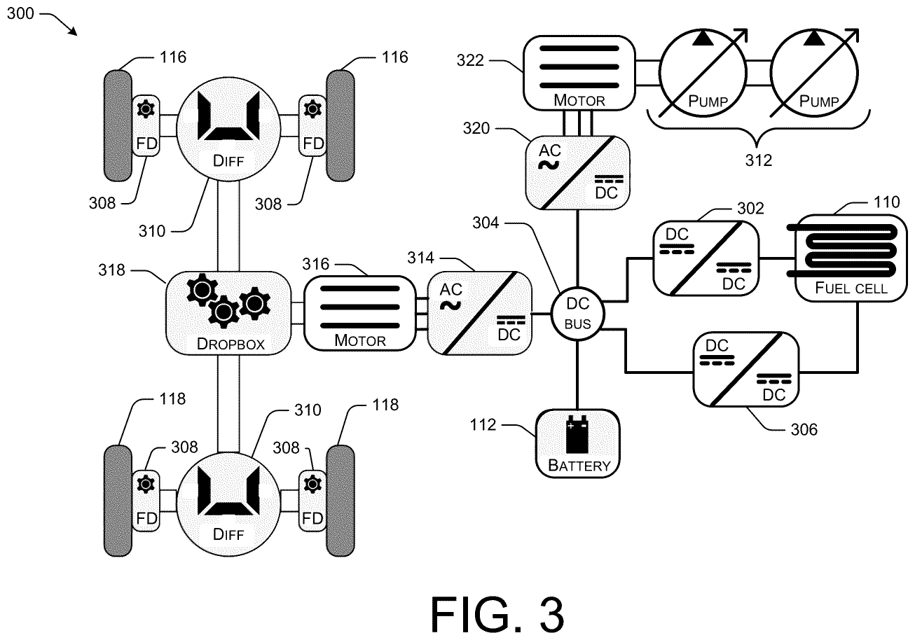

FIG. 3 is a block diagram model 300 of the machine 100 based on the machine recipe. The block diagram model 300 includes the fuel cell 110 and the battery 112 of the hybrid power source 108, the forward wheels 116, and the rearward wheels 118 as described above with reference to FIG. 1. A fuel cell BoP DC-DC converter 302 is coupled to a common DC bus 304 and an input of the fuel cell 110, and a stack DC-DC converter 306 is coupled to the common DC bus 304 and an output of the fuel cell 110 as described above with reference to FIG. 2. Each of the forward wheels 116 and rearward wheels 118 is coupled to, and driven by, a final drive 308. The block diagram model 300 further includes the differential steers 310, and the dual pump system 312, as described above with reference to FIG. 2. The block diagram model 300 additionally includes an inverter 314 coupled to the common DC bus 304 and an electric motor 316 as the prime mover driving a dropbox 318, which is coupled to the differential steers 310. Another inverter 320 is coupled to the common DC bus 304 and an electric motor 322 driving the dual pump system 312. The fuel cell 110, the battery 112, and electric motors 316 and 322 are examples of powertrains.

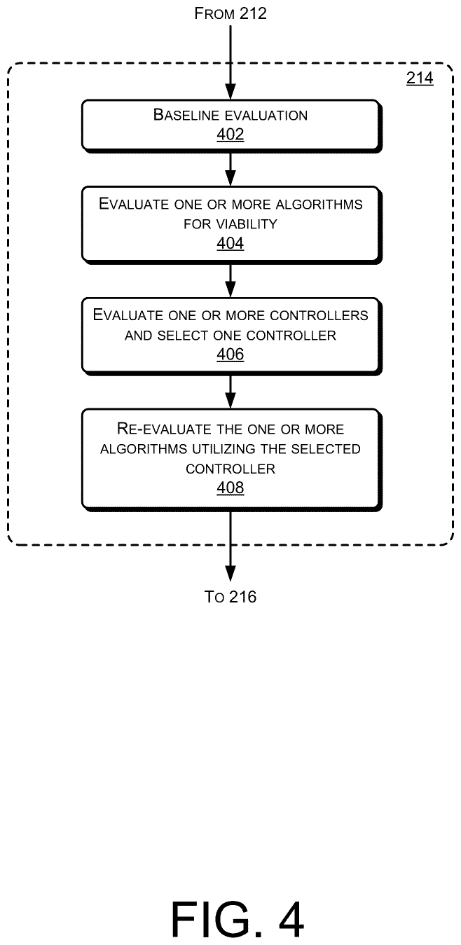

FIG. 4 is a flowchart representing an example detail process of block 214 of FIG. 2. At block 402, a baseline performance is evaluated. For example, the baseline performance may be evaluated based on heuristic rule based controls, such as 1) the fuel cell current output is presumed to meet common bus load demand, and to charge the battery to a target SoC of 80%; and 2) the battery 112 is presumed to cover transient loads while the fuel cell 110 is ramping up and down to meet the new load. The CPU score for the baseline evaluation may have a CPU score of 52.

At block 404, one or more algorithms are evaluated for viability. For example, a thermal adaptive equivalent consumption minimization strategy (A-EMCS) may be determined to be not applicable if no thermal loads were to be tracked, while a general A-EMCS may be determined to be viable with a CPU score of 70, for example. A model predictive control (MPC) with and without an automated or assisted operation program, such as a digging operation with the machine 100, may also be evaluated. To evaluate an MPC, a load profile may be run against multiple MPC models and solvers. For an MPC without the automated operation program, the load may be determined to be too variable for a horizon match for the MPC, where the horizon match is the ability of the algorithm to predict oncoming load based on different solver methods. For an MPS with the automated program, however, the load may be determined to be predictable for the horizon match for the MPC, resulting in medium viability with a CPU score of 94, which allows utilizing a frozen time prediction model with a linear timing varying (LTV) solver, where the frozen time prediction model considers past data over a specific time window to predict future load and may allow simplifying the application. For example, if the driver has been going at a set speed for the last 10 minutes then the future load may be assumed to be similar with constant speed and variable torque.

Additionally, a dynamic programming may be evaluated based on the KPIs selected. Dynamic programming is defined as a computer programming technique where an algorithmic problem is first broken down into sub-problems, the results are saved, and then the sub-problems are optimized to find the overall solution including finding the maximum and minimum range of the algorithmic query. If the number of KPIs selected is low, then the dynamic programming may be viable with a CPU score of 156.

At block 406, one or more controllers are evaluated, and one controller is selected. Number of datalinks are determined by the amount of signals required, the speed of data from each connected controller, the length of cable between controllers, and the function of each controller. A supervisory controller is evaluated based on CPU capability, and the datalinks determine what signals reside for the outputs of the optimized algorithm. Some controllers can only handle one datalink, and if two datalinks are required, then that controller is eliminated as a potential supervisory controller. Controllers are chosen by the I/O required and also by required CPU capability, i.e., CPU capability requirements, if there are multiple options. For example, a first controller may utilize two datalinks and have a CPU score of 89, while a second controller utilizing a single datalink may have CPU score of 124. If two datalinks were required for the controller, then the first controller may be selected.

At block 408, the baseline and the one or more algorithms from block 404 may be re-evaluated utilizing the selected controller, i.e., the first controller. Controllers with a low, med, and high complexity application may be evaluated, and baseline algorithms for each type of optimization may be determined. The CPU capability may then be benchmarked by compiling the software with the application, which provides CPU power requirement for each algorithm type. Based on the CPU power requirements, the application and the algorithm for compatibility on the controller options may be ranked or scored. For example, the baseline, which is the original rule based control and a simplest application of control, may still be determined to be viable while the dynamic programming may be determined to require excessive computational resources; the A-ECMS may be determined to be viable; and the MPC with the automated or assisted operation program may be determined to viable if the KPIs were simplified or reduced.

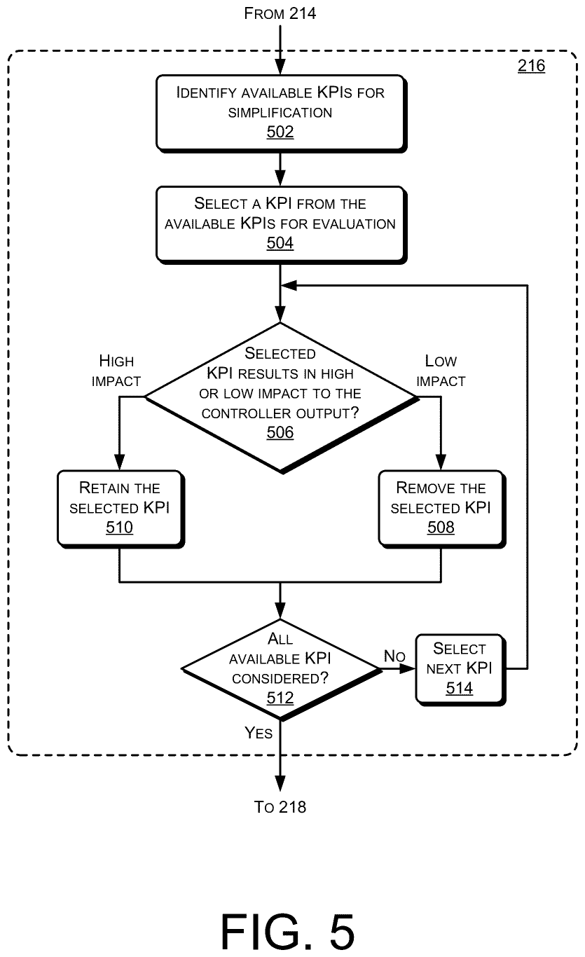

FIG. 5 is a flowchart representing an example detail process of block 216 of FIG. 2. As describe above with reference to FIG. 4, the baseline and the A-ECMS are determined to be viable and require no simplification while the MPC with the automated or assisted operation program will require the KPIs to be simplified to be viable.

At block 502, KPIs available for simplification may be identified, which excludes high priority KPIs. For example, the total efficiency for the machine 100 may be considered high priority from requirements controlled by DC-DC current output and its effect on H2 consumption by the fuel cell 110. Because the target SoC of the battery 112 is required for the algorithm for total efficiency and battery constraints, the target SoC may be considered high priority. The total efficiency and the target SoC, therefore, may be excluded from the KPI simplification while other KPIs are available for simplification. KPIs requiring adjusting over a life of the machine may also be excluded, such as net kW, i.e., total efficiency, total cost of ownership, runtime, i.e., reliability, uptime, and tons per kWhr.

At block 504, a KPI from the available KPIs may be selected. The KPIs available may include the fuel cell SoH optimization opportunity and the battery SoH optimization opportunity. At block 506, whether the selected KPI results in high or low impact to the controller output is evaluated. If the impact is determined to low, the selected KPI may be removed from the algorithm at block 508. If the impact is determined to high, the selected KPI may be retained in the algorithm at block 510. At block 512, whether all available KPIs have been considered is determined. If there are still one or more available KPIs to be considered, a next KPI is selected at block 514, and the process repeats from block 506 until all available KPIs have been considered. If it is determined at block 512 that all KPIs have been considered, then the process proceeds to block 218.

In this example, the MPC with the automated or assisted operation program (algorithm) may be evaluated with and without considering the battery SoH optimization opportunity to determine the impact level of the battery SoH. Due to the battery 112 directly connected to the common DC bus 304 and the fuel cell response constraints, the battery SoH optimization opportunity may be determined to have low impact on the algorithm and may be removed from the algorithm. The algorithm without considering the battery SoH optimization opportunity may result in a CPU score of 91. Next, the algorithm may be evaluated with and without considering the fuel cell SoH with the battery SoH optimization opportunity removed. The fuel cell SoH may also be determined to have low impact and may be removed from the algorithm. The algorithm without the battery SoH optimization opportunity and fuel cell SoH may result in a CPU score of 88. The fuel cell SoH will have a variable for transient, average load, start/stop events, purge time, and fault events including variables for the balance of plant components. For example, to avoid disregarding the impact of the fuel cell, these variables may be replaced with a transient cost, or a fuel cell penalty cost, which may result in a CPU score 89 and make the algorithm viable.

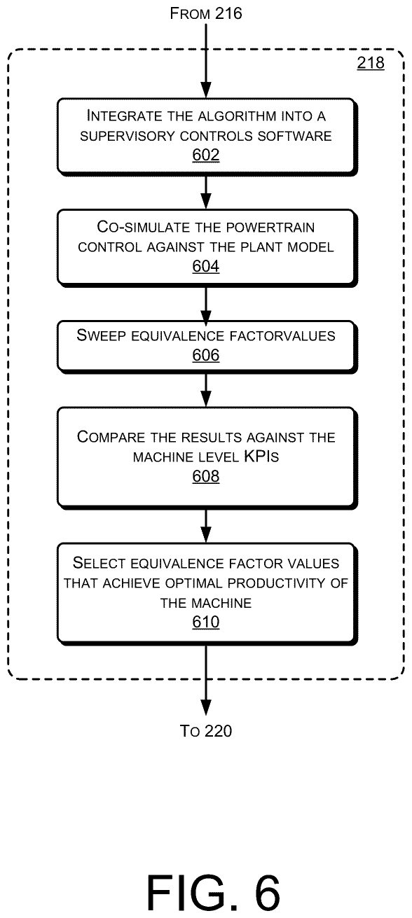

FIG. 6 is a flowchart representing an example detail process of block 218 of FIG. 2. At block 602, the algorithm may be integrated into a supervisory control software. Supervisory control software contains critical signals for performance, operating modes, diagnostics, and events that are required for the machine to function properly. The supervisory control software will accept critical signals from the algorithm for decision making, and advises the machine application software, The supervisory control software, however, can be overruled if a critical event or mode changes. At block 604, powertrain controls, i.e., controls connected to or associated with the powertrain, may be co-simulated against one of several tools such as the plant model. Co-Simulation means that the software is running with the plant model, but the tool used to develop the software is not directly compatible with the plant model and one or both processes must be adapted to work together. The plant model may be converted into a functional mock up (FMU) or reduced order model (ROM) to allow the controls to interface with a virtual representation of the machine in model format with different levels of fidelity. At block 606, equivalence factor values may be swept over a preselected range, such as from 0-100% of range. Equivalence factor values, or weighted values, are used to directly compare two or more KPIs against each other. For example, if KPI-A equivalence factor is 2 and KPI-B equivalence factor is 4, KPI-B has twice the influence compared to KPI-A. Certain KPIs, however, may be excluded from weighted factor comparison, such as KPIs requiring tuning and/or adjustments over a life of the machine. At block 608, the results from block 606 may be compared against the machine level KPIs including tons/hour, system efficiency, and/or acceleration time. The machine level KPIs may be influenced by machine speed and payload weight. For example, running the machine faster will affect the power supply output and heavier loads also require more power, creating a trade-off of more time charging and lower system efficiency. Controls KPIs may include component, sub-system, and/or system level that influence the machine level KPIs, such as hybrid power split, parasitic electrical efficiency, powertrain efficiency, DC-DC load sharing, etc. The controls KPI can consider speed, efficiency, and payload compared to the battery SoC, electrical efficiency, and charge time to balance the KPIs to maximize the tons per kWh power requirement. At block 610, equivalence factor values that achieve optimal productivity of the machine 100, such as tons per kWh machine requirements, are selected for the algorithm, and the process proceeds to block 220.

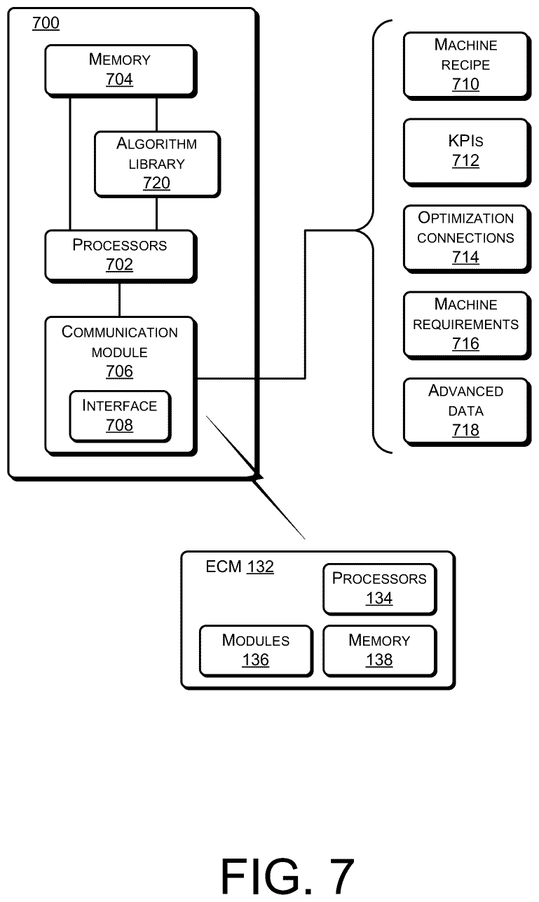

FIG. 7 is a block diagram of an optimizing power management system 700 for a hybrid power source of the machine and associated components. The optimizing power management system 700 may be hosted by a single server or distributedly hosted by a plurality of servers in a cloud environment. The optimizing power management system 700 may comprise one or more processors (processors) 702, memory 704 communicatively coupled to the processors 702, and a communication module 706 communicatively coupled to the processors 702. The communication module 706 may include an interface 708, such as a user interface and input/output (I/O) module capable of receiving inputs and providing outputs. The inputs and outputs may be communicated to and from the communication module 706 via a wired or wireless communication network, such as the Internet, a cellular network, local area network (LAN), wireless LAN (WLAN), and the like.

In some examples, the processors 702 may include a central processing unit (CPU), a graphics processing unit (GPU), both CPU and GPU, or other processing units or components known in the art. Additionally, each of the processors 702 may possess its own local memory, which also may store program modules, program data, and/or one or more operating systems. The memory 704 may comprise computer-readable media, which may include volatile memory (e.g., RAM), non-volatile memory (e.g., ROM, flash memory, miniature hard drive, memory card, or the like), or some combination thereof. The computer-readable media may be non-transitory computer-readable media. The computer-readable media may include or be associated with the one or more of the above-noted modules, which perform various operations associated with the optimizing power management system 700. In some examples, one or more of the modules may include or be associated with computer-executable instructions that are stored by the computer-readable media and that are executable by one or more processors to perform such operations.

For the purpose of discussion, unless otherwise specified, FIG. 7 will be described below with respect to the processors 702 of the optimizing power management system 700 performing the steps. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the process. The optimizing power management system 700 may also embody single or multiple microprocessors, field programmable gate arrays (FPGAs), digital signal processors (DSPs), programmable logic controllers (PLCs), etc.

The optimizing power management system 700 may generate a plant, or system, model is based a machine recipe 710, for example entered via the interface 708, for optimizing power management for a hybrid system of a desired machine, such as the hybrid power source 108 of the machine 100. As discussed above with referenced to FIG. 2, the machine recipe 710 may include various models for components of the machine 100. The optimizing power management system 700 may also receive selected KPIs 712 associated with the machine recipe 710, areas of optimization connections 714 from the digital twin, machine requirements 716 for the machine 100, and, if available, advanced data 718, as described above with reference to FIG. 2. The plant model may be generated by the processors 702, that select and input the machine recipe 710 and use stitching requirements to connect various models and components of the machine 100, to create the plant model. The optimizing power management system 700 may generate, in an algorithm library 720, algorithms based on the selected KPIs, the optimization connections, the machine requirements, and advanced data for a plurality of scenarios simulated and/or evaluated. The plurality of scenarios includes a baseline evaluation, algorithm determination, and controller benchmarking, with each scenario simulated given a CPU score that indicates computational requirements, and an algorithm may be selected based on the CPU score. Detailed description of generating the algorithm is provided above with reference to FIG. 4. In this example, the algorithm library 720 is shown as a module in the optimizing power management system 700. While suitable to be executed by a large computer or a computing system, such a cloud, or distributed computing system, such as the optimizing power management system 700, the algorithm generated may be too large to be executed by the processors 134 of the ECM 132 of the machine 100 in real-time.

The optimizing power management system 700 may then simplify the algorithm by removing KPIs having small impacts on the CPU score from the plurality of scenarios simulated, and may further refine the simplified algorithm by weighing, or prioritizing, retained KPIs. Detailed description of simplifying the algorithm and refining the simplified algorithm is provided above with reference to FIGS. 5 and 6. The refined algorithm may have a CPU score that is low enough such that it can be run on the processors 134 of the ECM 132 of the machine 100 to produce adequate results within a reasonable time period. The optimizing power management system 700 may integrate the refined algorithm into machine operation of the machine 100 to be performed by the ECM 132. In other words, machine operation program, code, or script that has integrated the refined algorithm, is loaded onto the memory 138 by the optimizing power management system 700, and the processors 134 execute the program for operating the machine 100.

The software and or functionality of the system(s), component(s), algorithms, cloud(s), platform(s), etc., discussed above with reference to FIGS. 2 and 4-6 regarding the optimizing power management system 700 may be combined in different ways depending on design requirements, ease of construction and/or integration, cost, etc. Accordingly, while these elements have been separated for purposes of discussion, they may be combined, as appropriate, during implementation.

The optimizing power management system 700 may be configured to use artificial intelligence for maintaining synchronization between centralized (cloud-based) and distributed models. The optimizing power management system 700 may include a centralized or cloud-based computer processing system located in one or more of a back-office server or a plurality of remote servers, one or more distributed, edge-based computer processing systems separately located with each of the distributed computer processing systems communicatively connected to the centralized computer processing system.

A machine learning engine may be included in at least one of the centralized and distributed computer processing systems. The machine learning engine may train a learning system using the training data to enable the machine learning engine to safely mitigate a divergence discovered between first and second sets of output control commands using a learning function including at least one learning parameter. Training the learning system may include providing the training data as an input to the learning function. The learning function may be configured to use the at least one learning parameter to generate an output based on the input, cause the learning function to generate the output based on the input, and compare the output to one or more of the first and second sets of output control commands to determine a difference between the output and the one or more of the first and second sets of output control commands. The learning function may modify the at least one learning parameter and the output of the learning function to decrease the difference responsive to the difference being greater than a threshold difference and under a variety of different conditions.

### INDUSTRIAL APPLICABILITY

The example systems and methods of the present disclosure are applicable for optimizing power management for a hybrid system of a machine, such as an automobile, a truck, an agricultural vehicle, an aircraft, a watercraft, and/or work vehicles, such as a track loader, a skid-steer loader, a grader, an on-highway truck, an off-highway truck, and/or any other machine known to a person skilled in the art. The systems and methods described herein may be used to reduce and optimize a machine operation program size and complexity such that the optimized machine operation program can be loaded onto, and executed by, an electronic control module of the machine. For example, a plant model based on a machine recipe of the machine may be generated, and algorithms may be generated, in an algorithm library, for a plurality of scenarios simulated based on selected key performance indicators (KPIs) associated with the machine recipe, optimization connections, and machine requirements of the machine. An algorithm may be selected from the algorithm library based on computational capabilities of a controller associated with the machine and machine requirements for the algorithm. A central processing unit (CPU) score for a corresponding algorithm of the plurality of algorithm may be calculated where the CPU score indicates computational requirements of the corresponding algorithm, and the algorithm may be selected from the algorithms generated based on the CPU score of the algorithm. The algorithm may be simplified based on removing one or more KPIs of the selected KPIs by identifying available KPIs for simplifying the algorithm, determining whether each KPI of the available KPIs has high impact or low impact on a controller associated with the algorithm, and removing KPIs determined to have low impact on the controller associated with the algorithm. The algorithm may then be refined based on weighing one or more remaining KPIs of the selected KPIs by integrating the algorithm into a supervisory control software, the supervisory control software containing critical signals for performance, operating modes, diagnostics, and events that the machine require to function properly, co-simulating controls associated with a powertrain of the machine against the plant model, sweeping equivalence factor values over a preselected range for the one or more remaining KPIs, comparing results from the sweeping the equivalence factor values against machine level KPIs; and selecting equivalence values resulting in optimal productivity of the machine. The refined algorithm may then be integrated into machine operation to be performed by the control module of the machine.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the examples above, it will be understood by those skilled in the art that various additional embodiments may be contemplated by the modification of the disclosed devices, systems, and methods without departing from the spirit and scope of what is disclosed. Such embodiments should be understood to fall within the scope of the present disclosure as determined based upon the claims and any equivalents thereof.

What is claimed is:

1. A method for optimizing power management for a hybrid system of a machine, the method comprising:
generating a plant model based on a machine recipe of the machine;
generating, in an algorithm library, algorithms for a plurality of scenarios simulated based on selected key performance indicators (KPIs) associated with the machine recipe, optimization connections, and machine requirements of the machine;
selecting an algorithm from the algorithm library based on computational capabilities of a controller associated with the machine and machine requirements for the algorithm;
simplifying the algorithm based on removing one or more KPIs of the selected KPIs;
refining the algorithm based on weighing one or more remaining KPIs of the selected KPIs; and
integrating the algorithm into machine operation to be performed by a control module of the machine.

2. The method of claim 1, wherein the machine recipe includes one or more models for:
a power source of the machine,
a bus architecture of the machine,
a drivetrain of the machine, and
hydraulics of the machine.

3. The method of claim 1, wherein the optimization connections are selected from optimization connections from a digital twin model of the machine, the digital twin model including electrical and mechanical connections to a controller specific to the machine.

4. The method of claim 1, wherein generating, in the algorithm library, the algorithms for the plurality of scenarios simulated is further based on advanced data associated with the machine, the advanced data including machine automation information of the machine and site data associated with locations of machine operations, chargers, and refueling stations.

5. The method of claim 1, wherein the plurality of scenarios simulated includes at least one of:
a baseline performance of the machine based on heuristic rule based controls,
a thermal adaptive equivalent consumption minimization strategy (A-EMCS) for the machine,
a model predictive control (MPC) with an automated program for the machine,
an MPC with an assisted operation of the machine,
an MPC without the automated or assisted operation program,
a dynamic programming wherein an algorithmic problem is first broken down into sub-problems and then the sub-problems are optimized to find an overall solution, or
one or more controller based on input/output (I/O) requirements and a central processing unit (CPU) capability requirements.

6. The method of claim 1, wherein generating the algorithms for the plurality of scenarios simulated includes calculating a central processing unit (CPU) score for a corresponding algorithm of the plurality of algorithms, the CPU score indicating computational requirements of the corresponding algorithm.

7. The method of claim 6, wherein selecting the algorithm from the algorithms generated based on the computational requirements of the algorithm includes selecting the algorithm based on the CPU score of the algorithm.

8. The method of claim 1, wherein simplifying the algorithm based on removing the one or more KPIs of the selected KPIs include:
identifying available KPIs for simplifying the algorithm, the available KPIs excluding KPIs requiring adjusting over a life of the machine;
determining whether each KPI of the available KPIs has high impact or low impact on a controller associated with the algorithm; and
removing KPIs determined to have low impact on the controller associated with the algorithm.

9. The method of claim 1, wherein refining the algorithm based on weighing one or more remaining KPIs of the selected KPIs includes:
integrating the algorithm into a supervisory control software, the supervisory control software containing critical signals for performance, operating modes, diagnostics, and events that the machine requires to function properly;
co-simulating controls associated with a powertrain of the machine against the plant model;
sweeping equivalence factor values over a preselected range for the one or more remaining KPIs;
comparing results from the sweeping the equivalence factor values against machine level KPIs; and
selecting equivalence values resulting in optimal productivity of the machine.

10. A system for optimizing power management for a hybrid system of a machine comprising:
one or more processors; and
memory communicatively coupled to the one or more processors, the memory storing thereon processor-executable instructions that, when executed by the one or more processors, cause the one or more processors to perform operations comprising:
generating a plant model based on a machine recipe of the machine;
generating, in an algorithm library, algorithms for a plurality of scenarios simulated based on selected key performance indicators (KPIs) associated with the machine recipe, optimization connections, and machine requirements of the machine;
selecting an algorithm from the algorithm library based on computational capabilities of a controller associated with the machine and machine requirements for the algorithm;
simplifying the algorithm based on removing one or more KPIs of the selected KPIs;
refining the algorithm based on weighing one or more remaining KPIs of the selected KPIs, the one or more remaining KPIs excluding KPIs requiring adjusting over a life of the machine; and
integrating the algorithm into machine operation to be performed by a control module of the machine.

11. The system of claim 10, wherein:
the machine recipe includes one or more models for:
a power source of the machine,
a bus architecture of the machine,
a drivetrain of the machine, and
hydraulics of the machine, and
the optimization connections are selected from optimization connections from a digital twin model of the machine, the digital twin model including electrical and mechanical connections to a controller specific to the machine.

12. The system of claim 10, wherein generating, in the algorithm library, the algorithms for the plurality of scenarios simulated is further based on advanced data associated with the machine, the advanced data including machine automation information of the machine and site data associated with locations of machine operations, chargers, and refueling stations.

13. The system of claim 10, wherein the plurality of scenarios simulated includes at least one of:
a baseline performance of the machine based on heuristic rule based controls,
a thermal adaptive equivalent consumption minimization strategy (A-EMCS) for the machine,
a model predictive control (MPC) with an automated program for the machine,
an MPC with an assisted operation of the machine,
an MPC without the automated or assisted operation program,
a dynamic programming wherein an algorithmic problem is first broken down into sub-problems and then the sub-problems are optimized to find an overall solution, or
one or more controller based on input/output (I/O) requirements and a central processing unit (CPU) capability requirements.

14. The system of claim 10, wherein:
generating the algorithms for the plurality of scenarios simulated includes calculating a central processing unit (CPU) score for a corresponding algorithm of the plurality of algorithms, the CPU score indicating computational requirements of the corresponding algorithm, and
selecting the algorithm from the algorithms generated based on computational requirements of the algorithm includes selecting the algorithm based on the CPU score of the algorithm.

15. The system of claim 10, wherein simplifying the algorithm based on removing the one or more KPIs of the selected KPIs include:
identifying available KPIs for simplifying the algorithm;
determining whether each KPI of the available KPIs has high impact or low impact on a controller associated with the algorithm; and
removing KPIs determined to have low impact on the controller associated with the algorithm.

16. The system of claim 10, wherein refining the algorithm based on weighing the one or more remaining KPIs of the selected KPIs includes:
integrating the algorithm into a supervisory control software, the supervisory control software containing critical signals for performance, operating modes, diagnostics, and events that the machine requires to function properly;
co-simulating controls associated with a powertrain of the machine against the plant model;
sweeping equivalence factor values over a preselected range for the one or more remaining KPIs;
comparing results from the sweeping the equivalence factor values against machine level KPIs; and
selecting equivalence values resulting in optimal productivity of the machine.

17. Non-transitory computer-readable medium storing thereon processor-executable instructions that, when executed by one or more processors of a system, cause the one or more processors to perform operations for optimizing power management for a hybrid system of a machine, the operations comprising:
generating a plant model based on a machine recipe of the machine;
generating, in an algorithm library, algorithms for a plurality of scenarios simulated based on selected key performance indicators (KPIs) associated with the machine recipe, optimization connections selected from a digital twin of the machine, and machine requirements of the machine;
selecting an algorithm from the algorithm library based on computational capabilities of a controller associated with the machine and machine requirements for the algorithm;
simplifying the algorithm based on removing one or more KPIs of the selected KPIs;
refining the algorithm based on weighing one or more remaining KPIs of the selected KPIs; and
integrating the algorithm into machine operation to be performed by a control module of the machine.

18. The non-transitory computer-readable medium of claim 17, wherein generating, in the algorithm library, the algorithms for the plurality of scenarios simulated is further based on advanced data associated with the machine, the advanced data including machine automation information of the machine and site data associated with locations of machine operations, chargers, and refueling stations.

19. The non-transitory computer-readable medium of claim 17, wherein:
generating the algorithms for the plurality of scenarios simulated includes calculating a central processing unit (CPU) score for a corresponding algorithm of the plurality of algorithms, the CPU score indicating computational requirements of the corresponding algorithm,
selecting the algorithm from the algorithms generated based on computational requirements of the algorithm includes selecting the algorithm based on the CPU score of the algorithm, and
simplifying the algorithm based on removing the one or more KPIs of the selected KPIs includes:
identifying available KPIs for simplifying the algorithm, the available KPIs excluding KPIs requiring adjusting over a life of the machine;
determining whether each KPI of the available KPIs has high impact or low impact on a controller associated with the algorithm; and
removing KPIs determined to have low impact on the controller associated with the algorithm.

20. The non-transitory computer-readable medium of claim 17, wherein refining the algorithm based on weighing one or more remaining KPIs of the selected KPIs includes:
integrating the algorithm into a supervisory control software, the supervisory control software containing critical signals for performance, operating modes, diagnostics, and events that the machine requires to function properly;
co-simulating controls associated with a powertrain of the machine against the plant model;
sweeping equivalence factor values over a preselected range for the one or more remaining KPIs;
comparing results from the sweeping the equivalence factor values against machine level KPIs; and
selecting equivalence values resulting in optimal tons per kWh machine requirements.
